(19) United States
(12) Patent Application Publication
(10) Pub. No.: US 2025/0103955 A1
(43) Pub. Date: Mar. 27, 2025

(54) DISTRIBUTED LEARNING USING MOBILE NETWORK TOPOLOGY INFORMATION

(71) Applicant: Telefonaktiebolaget LM Ericsson (publ), Stockholm (SE)

(72) Inventors: Filippo VANNELLA, Stockholm (SE); Johan HARALDSON, Stockholm (SE); Martin ISAKSSON, Stockholm (SE)

(21) Appl. No.: 18/725,325

(22) PCT Filed: Jan. 13, 2022
(86) PCT No.: PCT/EP2022/050586

§ 371 Date: Jun. 28, 2024

(51) Int. Cl. G06N 20/00; H04W 24/02

(52) U.S. Cl. CPC G06N 20/00; H04W 24/02

(57) ABSTRACT

A computer-implemented method for distributed machine learning, performed in a wireless access network including a plurality of nodes. The method includes: defining a set of neighbor relation edges which connect at least some of the nodes of the wireless access network, where each neighbor relation edge is associated with at least one neighbor relation (KPI), selecting a subset of the neighbor relation edges for each node, wherein the selected subset of neighbor relation edges is associated with one or more neighbor relation KPI that meets a pre-determined acceptance criterion, forming a relational graph for each node based on the respective selected subset of neighbor relation edges for the node, and performing distributed machine learning over the nodes in the wireless access network based on the formed relational graph for each node.

### TECHNICAL FIELD

The present disclosure relates to mobile access networks, and in particular to methods for optimizing the performance of such networks using machine learning techniques. The disclosed methods are particularly suitable for use in third generation partnership program (3GPP) defined networks, but may also find uses in other types of networks. There are disclosed methods, network nodes, and network management tools for network optimization, as well as computer programs and computer program products configured for facilitating network optimization.

### BACKGROUND

Modern wireless access networks are complex systems which comprise numerous control and monitoring functions. The operation of the network and its configuration is often continuously or at least periodically adapted based on the control and monitoring functions in order to improve network performance in terms of, e.g., coverage, throughput, security and robustness.

Machine learning techniques have been proposed for this type of optimization, with very promising results. For instance, E. Balevi and J. G. Andrews discuss antenna configuration techniques based on reinforcement learning (RL) in “Online Antenna Tuning in Heterogeneous Cellular Networks with Deep Reinforcement Learning,” published in the IEEE Transactions on Cognitive Communications and Networking, vol. 5, no. 4, pp. 1113-1124, 2019.

Automatic antenna configuration is also discussed in “Self-tuning of Remote Electrical Tilts Based on Call Traces for Coverage and Capacity Optimization in LTE” by V. Buenestado, M. Toril, S. Luna-Ramírez, J. Ruiz-Aviles, and A. Mendo, IEEE Transactions on Vehicular Technology vol. 66(5), pp. 4315-4326, 2017.

An overview of multi-agent reinforcement learning (MARL) techniques is given by L. Buşoniu, R. Babuška, and B. De Schutter, in “Multi-agent reinforcement learning: An overview,” Chapter 7 in Innovations in Multi-Agent Systems and Applications—1 (D. Srinivasan and L. C. Jain, eds.), vol. 310 of Studies in Computational Intelligence, Berlin, Germany: Springer, pp. 183-221, 2010.

A frequent problem in applying machine learning techniques in wireless access networks is that data can normally not be freely shared among participating processes, due to privacy issues and the like. Also, the state-space often becomes prohibitively large for many problems and applications associated with wireless access network optimization.

There is a need for improved techniques which facilitate the application of distributed machine learning techniques in wireless access networks.

### SUMMARY

It is an object of the present disclosure to provide techniques which facilitate distributed machine learning in an efficient and accurate manner, primarily for applications in wireless access networks. This object is at least in part obtained by a computer-implemented method for distributed machine learning, performed in a wireless access network that comprises a plurality of nodes. The method comprises defining an initial set of neighbor relation edges which connect at least some of the nodes of the wireless access network, where each neighbor relation edge in the initial set of neighbor relation edges is associated with at least one neighbor relation (KPI). The neighbor relation KPI is a metric which indicates the performance of some form of interaction involving two cells connected by a neighbor relation edge, such as a rate of successful handovers, a measure of the number of devices which moves from one cell to the other, or a measure of the data traffic on an X2 interface between the two cells. i.e. between two nodes serving two different cells. A key component in the method is that it comprises selecting a subset of the neighbor relation edges for each node, wherein the selected subset of neighbor relation edges is associated with one or more neighbor relation KPI that meets a pre-determined acceptance criterion. The concept of a node in the wireless access network is to be construed broadly herein. An access point in the wireless access network may constitute a node, but also a cell forming part of an access point. A network function performed in the wireless access network may also be considered a node in a logical context, connected to other network functions via neighbor relation edges. This selection can be seen as a form of filtering, where the number of neighbor relation edges in the initial set of neighbor relation edges are pruned, leaving a smaller number of neighbor relation edges deemed particularly relevant. The method furthermore comprises forming a relational graph for each node based on the respective selected subset of neighbor relation edges for the node, and performing distributed machine learning over the nodes in the wireless access network based on the formed relational graph for each node. The relational graph describes the layout of the nodes in the wireless access network (be it access points, cells, network functions, etc) and the neighbor relation edges there in-between.

This way, information about the network topology and the interaction between neighboring cells in the network is exploited to create a graph that captures similarity between the cells in the wireless access network. This pruned relational graph is a similarity map of sorts which can be used to make distributed machine learning in the wireless access network more efficient from a performance point of view. The pruned relational graph is helpful in the sense that the number of edges between nodes is reduced, which reduces overall complexity in training, i.e., the method often reduces the computational load on a processing device which performs the machine learning. The pruned relational graph is also helpful in the sense that nodes which are not particularly related are allowed to be updated more or less independently of each other, which may speed up the convergence time of the training phase.

According to some aspects, the method comprises defining the set of neighbor relation edges as edges associated with a hand-over related KPI and/or a user mobility related KPI. These KPIs are readily available in many wireless networks today, which is an advantage. Also, hand-over related KPIs and user mobility related KPIs have been shown to be a good measure of similarity for the purposes of forming the pruned relational graph. Generally, a neighbor relation KPI preferably represents a metric which involves operations in at least two nodes in the plurality of nodes.

Each neighbor relation edge is optionally associated with a 3GPP X2 connection between two nodes in the wireless access network. Thus, the initial set of neighbor relation edges is already available in many wireless access networks today, which is an advantage. The 3GPP X2 interface is discussed in, e.g., 3GPP TS 32.420 V16.0.0. According to some other aspects, the method comprises executing an automated neighbor relations (ANR) procedure to define the set of neighbor relation edges. The 3GPP ANR is specified in 3GPP TS 32.511 V16.0.0.

The method may comprise obtaining one or more of the neighbor relation KPIs from a network data analytics function (NWDAF) of the wireless access network. e.g., as detailed in 3GPP TS 23.288 V17.0.0. This means that neighbor relation KPIs can be obtained from nodes not directly connected to the node performing the method, which is an advantage. The NWDAF architecture is suitable for the dissemination of neighbor relation KPIs. and represents an efficient means for obtaining at least some of the data used to construct the relational graph for each node, or a global relational graph for the whole network. Indeed, the NWDAF may form the relational graph on its own, and then distribute the respective relational graphs to the used. The NWDAF may also determine weights which can be assigned to the edges in the relational graph, as will be discussed in more detail below.

According to some further aspects, the method comprises selecting the subset of the neighbor relation edges for each node as a pre-determined number of neighbor relation edges among the neighbor relation edges associated with highest neighbor relation KPI. This way to prune the initial set of neighbor relation edges is associated with reduced computational complexity compared to other more complex pruning methods, which is an advantage in some systems, e.g., where processing resources are limited and/or where processing delay constraints are tight. The pre-determined number can be a pre-configured number, or adapted based on some performance metric, such as an accuracy of inference determined continuously or periodically by some node in the wireless access network. Alternatively, the method may comprise selecting the subset of the neighbor relation edges for each node as the neighbor relation edges having respective neighbor relation KPIs above a pre-determined acceptance threshold. This acceptance threshold can also be pre-configured or adapted over time in order to reach some target performance or level of computational complexity. A fraction of edges can also be selected. i.e., the method can be configured to only maintain. e.g., the top 70% of edges, or some other pre-determined or adaptable fraction of edges. Another way of selecting the subset of the neighbor relation edges for each node is by using standard feature selection methods such as forward selection, backwards elimination, or recursive feature elimination (RFE).

The method preferably comprises performing the distributed machine learning in the wireless access network as a reinforcement learning (RL) procedure involving a plurality of RL agents, such as a MARL. When using MARL, the method may comprise initializing a plurality of RL agents, where each RL agent is associated with a node in the wireless access network and also with a respective RL agent policy, where the method further comprises updating the RL policy of an RL agent associated with a node based on one or more gradient updates received from other RL agents in the relational graph for the node. However, other forms of distributed machine learning are of course also possible, such as various forms of federated learning (FL), or some form of Deep Q-Learning (DQN).

According to further aspects, the method comprises registering each RL agent by a network repository function (NRF) of the wireless access network. This allows other nodes in the network to discover the RL agent, and interact with the agent, which is an advantage. This function allows a new agent to attach to an existing machine learning structure, and it also allows existing agents to incorporate data from a new agent which has recently been initialized and configured to partake in some distributed machine learning process.

Generally, the methods disclosed in the following may comprise performing an optimization of a network parameter associated with the wireless access network as a distributed machine learning procedure based on the formed relational graphs, i.e., based on the subset of the neighbor relation edges in the initial set of neighbor relation edges. The network parameter may for instance comprise an antenna tilt parameter, but many example parameters possible to optimize can be considered. An extended but non-exhaustive list of example parameters which are possible to optimize using the techniques discussed herein will be given in the detailed description below. The methods disclosed herein may furthermore comprise performing secondary carrier prediction in the wireless access network as a distributed machine learning procedure based on the formed relational graphs.

The above-mentioned advantages are also obtained by computer programs, computer program products, and network nodes, as will be discussed in more detail below.

### BRIEF DESCRIPTION OF THE DRAWINGS

The present disclosure will now be described in more detail with reference to the appended drawings, where:

FIG. 1 shows an example wireless communication system built around a core network;

FIG. 2 illustrates network functions and interfaces in a 3GPP-defined network;

FIG. 3 schematically illustrates a network data analytics system from a functional perspective;

FIG. 4 schematically illustrates cell neighbor relations between nodes in a wireless access network;

FIG. 5 is a graph which illustrates distributed machine learning dependencies in a network;

FIGS. 6A-B are flow charts illustrating example methods;

FIG. 7 is a flow chart illustrating another example method;

FIG. 8 schematically illustrates an example wireless access network implementation;

FIG. 9 schematically illustrates a general realization of processing circuitry; and

FIG. 10 schematically illustrates an example computer program product;

### DETAILED DESCRIPTION

Aspects of the present disclosure will now be described more fully hereinafter with reference to the accompanying drawings. The different devices, systems, computer programs and methods disclosed herein can, however, be realized in many different forms and should not be construed as being limited to the aspects set forth herein. Like numbers in the drawings refer to like elements throughout.

The terminology used herein is for describing aspects of the disclosure only and is not intended to limit the invention. As used herein, the singular forms “a”, “an” and “the” are intended to include the plural forms as well, unless the context clearly indicates otherwise.

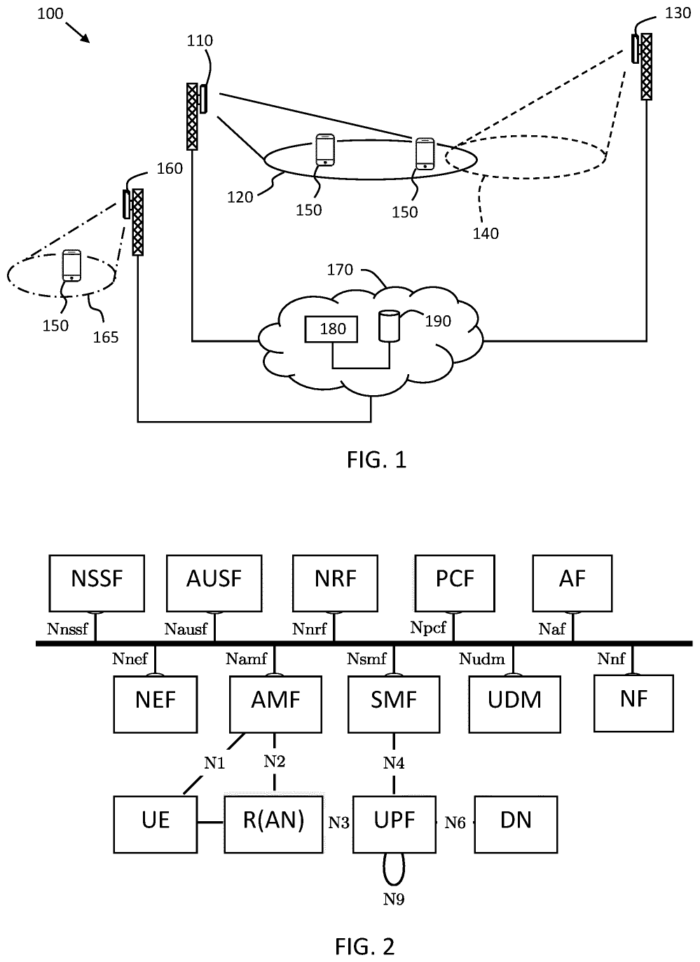

FIG. 1 schematically illustrates an example wireless access network 100 comprising radio access network nodes 110, 130, 160 which provide wireless access to wireless devices 150 (often referred to as user equipment, or UE) over a plurality of coverage areas 120, 140, 165. The radio access network nodes are connected to a core network 170. The wireless devices 150 connect to the core network 170 via the radio access network nodes 110, 130, 160, whereby they become communicatively coupled to, e.g., processing resources 180 and data repositories 190 in the core network 170, as well as to each other.

The network 100, or system, may be part of a fifth generation (5G) communication system (5GS) as defined by the 3GPP. However, the techniques disclosed herein are generally applicable, and can be implemented in other communication systems also, such as a 3GPP 4G system. At least some of the techniques discussed herein are also applicable in future communication systems yet to be deployed, such as a 3GPP sixth generation (6G) or a beyond 6G communication system.

The 3GPP created a framework for core network protocols in 5G called the Service Based Architecture (SBA), some parts of which are schematically illustrated in FIG. 2. This framework is based on modern cloud technologies and provides a structure in which Application Programming Interfaces (APIs) and protocols are defined. Simply put, SBA comprises Network Functions (NFs) that expose services through APIs defined using OpenAPI employing HTTP/2 as transport.

The NFs expose services through RESTful APIs and can invoke services in other NFs via these APIs. For example, an NF of type Access and Mobility Management Function (AMF) may request subscriber authentication data from an NF of type Authentication Server Function (AUSF) by calling a function in the API of an AUSF for this purpose. In this scenario, the AMF is an example of a service consumer, and the AUSF is an example of a service producer.

To be discoverable to service consumers, service producers may register with an NF Repository Function (NRF). Once registered in the NRF, service consumers can discover the service producer. Upon request from an NF, the NRF responds with a list of identifiers for suitable service producers which fulfill the service criteria posed by the NF. For example, the NF may request a list of all service producers of a certain type.

As in previous 3GPP specifications, NFs define types of functions, e.g., AMF and AUSF. Strictly speaking, one should then say that an instance of AMF performs a certain action when describing protocols and system behavior. In some parts of the 3GPP specifications this distinction is clearly made in other parts it is not. The other entities in FIG. 2, starting from top left (with corresponding interfaces) are:
NSSF—Network Slice Selection Function,
PCF—Policy Control Function,
AF—Application Function,
NEF—Network Exposure Function,
SMF—Service Management Function,
UDM—Unified Data Management,
RAN—Radio Access Network,
UPF—User Plane Function, and
DN—Data Network.

ANR is a licensed feature that can add external nodes and cells, and cell relations used for HO and automatically set up X2 connections between cells. ANR reduces the need for manual configuration of neighbor cell relations which is helpful in optimizing mobility functions. The neighbor relations that are created by ANR make up a graph that spans the network where edges are made up of neighbor relations, and vertices are made up of cells. Each neighbor relation is associated with metadata and configuration parameters, but also with performance measurements. These measurements count for example the number of attempted HOs, the number of successful HOs, and so on.

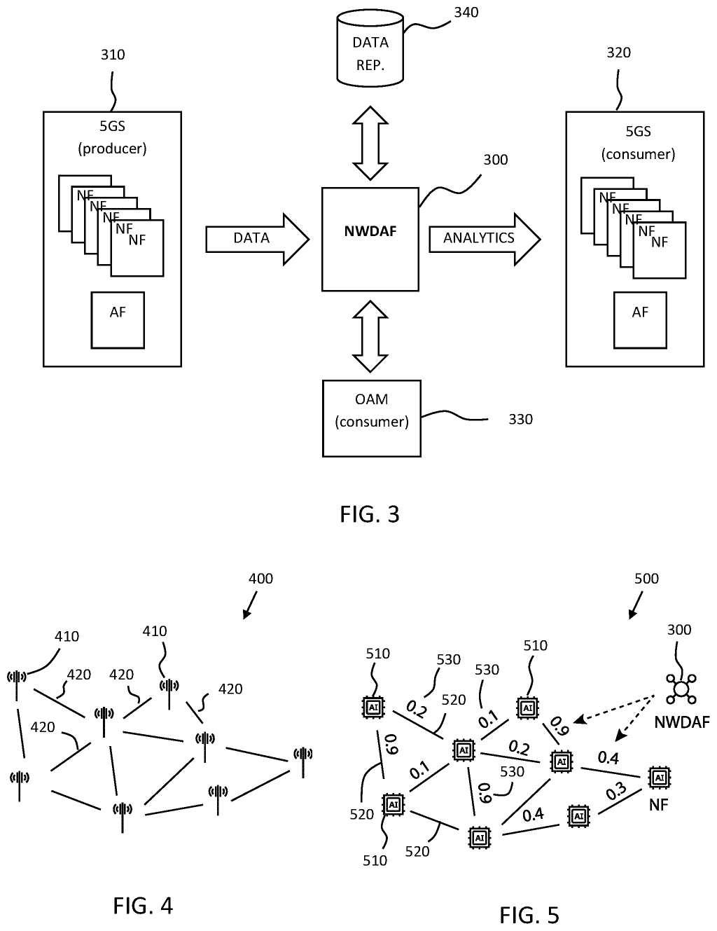

An operator wishing to obtain data for analysis of the operations, events, and statuses, in the network 100 may use the network analytics function (NWDAF) described in, e.g., 3GPP TS 23.288 V17.0.0, and schematically illustrated in FIG. 3, which is part of the 3GPP Network Data Analytics Framework (NWDA). NWDA. A target 5G system (5GS) 310 (where the data of interest for the analysis is generated) comprises a number of NFs and one or more AFs. Some commonly occurring example NFs in this context comprise UPFs, AMFs, and SMFs.

Various events and datapoints related to the operational data of the producer 5GS 310 can be subscribed to by the NWDAF 300 as detailed in 3GPP TS 23.288 V17.0.0. This data is then made available to an NWDAF service consumer which can be some other 5GS 320, an operations and maintenance (OAM) function 330, and/or a data repository 340. Thus, the term service consumer is to be interpreted broadly herein as any entity of function using the services provided in the NWDAF architecture. Any network node or function wishing to obtain analytical data from the NWDAF is associated with a NWDAF service consumer function (SCF). An NWDAF SCF may be implemented on one network node or distributed over several network nodes. Generally, the architecture allows an NWDAF SCF to subscribe to network analytics from the NWDAF, by sending an analytics subscription request for a given analytics function to the NWDAF, which will then feedback data to the SCF according to the definition of the analytics function. Thus, data collection in NWDA allows the NWDAF to retrieve data from various sources. This data can be Operations and Management (OAM) global NF data, data available in NFs, data available in the 5G core (for example in the NRF) or in AFs. The data collection procedures enable the NWDAF to efficiently obtain the appropriate data with the appropriate granularity.

Performance measurements (PM) that may be gathered and distributed via the NWDA may consist of performance statistics and events. Statistics are collected from measurements on live traffic in the radio and transport network. Events record traffic events for specific User Equipment (UE) or operator-selected cells. A performance event is created when a traffic event occurs, for example, when a UE makes a handover to another cell. For example, the NWDAF may provide NFs with output analytics such as average ratio of successful handovers.

It is noted that 3GPP TR 23.700-91 V17.0.0 2020 Dec. 17, and section 6.5 in particular, discusses machine learning (ML) model provisioning functions (MTLF).

What constitutes a “node” in the wireless access network 100 may vary between implementations of the herein proposed techniques. An access point may, for instance, constitute a node in the wireless access network 100. Such access points may also implement cell sectors, or beams, which may also be defined as nodes in the wireless access network 100. The network 100 may also comprise one or more logical functions, i.e., NFs. These functions may also represent nodes in some implementations. Thus, it is appreciated that a node is to be given a broad interpretation herein.

Two nodes may be connected by an edge, referred to below as a relational edge, which may form part of a relational graph. As for the definition of what constitutes a node in the wireless access network, the concept of an edge between two nodes is also to be construed broadly.

With reference to FIG. 1, some of the cells are more similar to each other compared to other cells. For instance, in the example of FIG. 1, the coverage areas 120, 140 are overlapping each other, such that a wireless device can traverse from one cell to the other via a handover operation in a known manner. The coverage area 165 is not overlapping the other two coverage areas 120, 140. Rather, it is geographically distanced from both area 120 and area 140, such that no wireless device can be handed over from the coverage area 165 to one of the other coverage areas. A key concept of the herein disclosed techniques is based on the realization that cell similarity can be measured in terms of one or more neighbor relation key performance indicators (KPI), such as the number of successful handovers performed between two cells, or some other mobility related KPI. This cell similarity can then be used to construct a relational graph for a distributed machine learning process, as will be explained in the following.

Machine learning techniques have, as discussed above, been applied with success in the optimization of various network parameters, such as antenna tilt. In geographically distributed machine learning frameworks, subsets of the overall data often belong to particular participating clients. These clients can for example be deployed on mobile phones or base stations where the generated local data is sensitive from a privacy or business perspective which means that the classical centralized machine learning solutions do not work.

A particularly interesting class of machine learning techniques which finds applications in wireless access network optimization, and where sharing of raw data is not strictly necessary are Reinforcement Learning (RL) techniques. RL is a decision-making paradigm in which an agent interacts directly with an environment to learn an optimal or at least a near-optimal control strategy. An RL method can be formalized as a Markov Decision Process (MDP), consisting of a tuple M of five elements, in a known manner, i.e.,
M=( [symbol] , [symbol] , p, r, γ), where
[symbol] is the set of possible states,
[symbol] is the set of possible actions.
p: [symbol] × [symbol] × [symbol] →[0,1] is the transition probability for going from state s to s′ when selecting a,
r: [symbol] × [symbol] →R is the reward function, received for being in a state s and taking action a, and
γ∈[0,1] is the discount factor, accounting for delayed observed rewards.

For some iteration index t≥1 (such as discrete time), the agent finds itself in state sₜ, executes action at by following a policy n that maps states to actions, transitions to the next state sₜ₊₁, and receives reward sample rₜ as a feedback. This interaction happens in a cycle where the agent evaluates and improves its policy π until it may eventually devise an optimal policy π*, maximizing a state-action value function Q^{π} (s, a). The state-action value function consists of the discounted expected cumulative rewards starting from state s and action a, with discount factor γ∈[0,1]. Formally, the value function can be expressed as

$${Q}^{π} ( s , a ) = {𝔼}_{π} [ \begin{matrix}{\sum }_{i = 0}^{∞} {γ}^{i} {r}_{t + i + 1} \vert {s}_{t} = s , & {a}_{t} = a\end{matrix} ]$$

where [symbol] π denotes expectation over the set of policies x. The RL objective can be formulated as

π*=arg max_{π}Q^{π}(s,a)

I.e., the policy π which maximizes the state-action value function Q^{π}(s, a).

Training a machine learning model in a geographically decentralized and distributed environment such as a wireless access network 100 is difficult since it may not always be allowed to share the raw data between participating entities, for instance due to privacy issues or the presence of legislative borders that prevent sharing of raw data. Often such sharing of raw data is not even possible due its size, i.e., due to the amount of communications resources necessary to transport the data between nodes. For instance, if the data comprises video or some other form of high rate data, then its size may be so large as to prevent sharing it over a wired or wireless communication link. Instead, one may train a machine learning structure on the local data and share the updates to the machine learning model (hereafter referred to as gradients, in keeping with the terminology accepted in the technical field of machine learning). In these systems it is however often the case that data is not independent and also not identically distributed from a statistical point of view. i.e., the data is non-IID in some respect, so using all available gradients from all nodes leads to a global machine learning model that is not particularity suitable for any of the participating entities. The gradients may also be relatively large in terms of data size. An object of the techniques discussed herein is to reduce the number of gradients which are communicated between the nodes in the system in order to reduce the amount of communicated data.

The present disclosure primarily investigates the use of distributed machine learning methods, such as multi-agent reinforcement learning (MARL) techniques or federated learning techniques, which are trained locally. In geographically distributed collaborative learning frameworks, the data belongs to and is local to each node and it is therefore logical that training takes place locally. Furthermore, there is a benefit of learning collectively, collaborate and coordinate within a locality (geographic proximity) of a node to improve a model or policy.

Distributed machine learning used in the context of complex wireless access networks is not without challenges. For instance, the majority of RL solutions for mobile network optimization use single-agent RL algorithms, incorporating information from neighbor cells into the state. This usually leads to RL solutions that do not consider any mechanism for coordination between actions in different cells, leading to possible disruptive dynamics between neighboring cells such as ping-pong effects between neighboring cells.

A coordinated solution including all nodes in the network will lead to state-action dimension explosion, and infeasible or intractable learning due to the increased number of agents as well as training instabilities. This greatly limits the applicability of MARL solutions for mobile network optimization use cases.

Coordinating between too many agents mean learning from and cooperating with agents that do not affect the model/policy or that will affect it in negative ways. Prior art solutions, such as those discussed in the introduction above do not disclose efficient ways of finding which agents to collaborate with that makes use of mobile network information.

Furthermore, collecting data centrally is not preferable in many cases due to the large volume of data and the sensitivity of data. Data can be private (relating to end users' personal data) or business sensitive (relating to our customers business sensitive data). Furthermore, even if data is not sensitive, it may become sensitive when combined with some other unknown dataset.

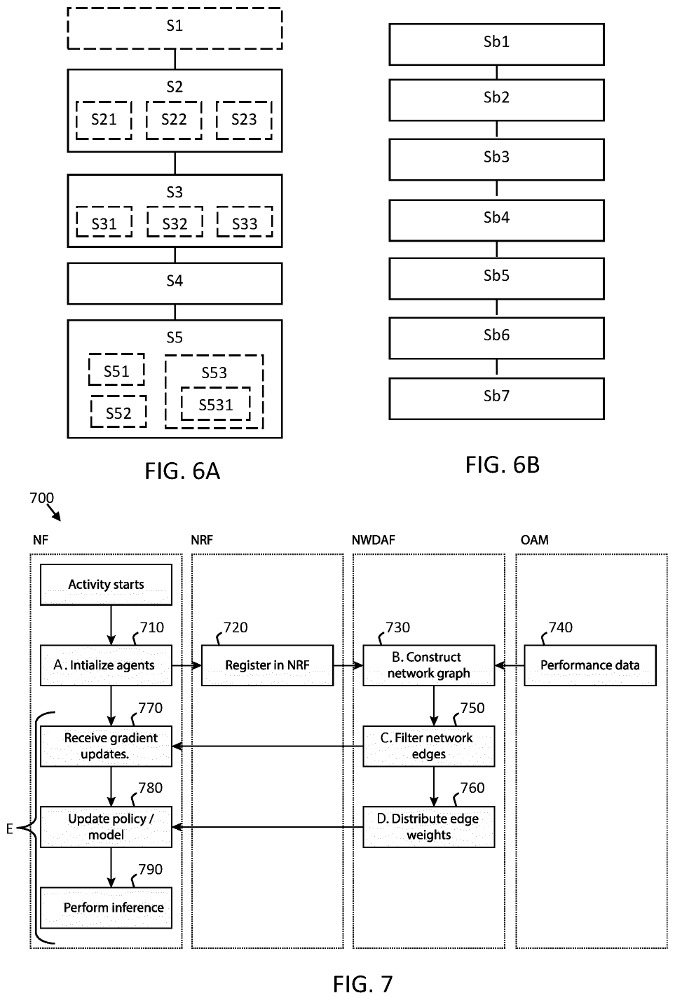

To overcome at least some of the challenges discussed above, there is disclosed herein a computer-implemented method for distributed machine learning, performed in a wireless access network 100, 400 comprising a plurality of nodes 110, 130, 160, 410. A flowchart of the method and its optional aspects is illustrated in FIG. 6A. The method comprises defining S2 a set of neighbor relation edges 420 which connect at least some of the nodes 110, 130, 160, 410 of the wireless access network, where each neighbor relation edge 420 is associated with at least one neighbor relation KPI. With reference to the example network graph 400 in FIG. 4, a basic or initial relational graph for training a distributed machine learning structure may advantageously be defined using information on currently configured 3GPP X2 connections 420 setup by an ANR process between network nodes 410, which is indicative of some degree of similarity. However, by then selecting a subset of the edges in the initial relational graph, i.e., pruning the graph, based on neighbor relation KPI, the number of edges in the relational graph can be reduced such that only the most similar nodes are maintained in each relational graph. This step of pruning an initial relational graph improves the efficiency of the distributed machine learning process considerably, and also improves the performance of the resulting inference by the trained machine learning structure. With reference to FIG. 4, each neighbor relation edge 420 is optionally associated with a 3GPP X2 connection between two nodes 110, 130, 160, 410 in the wireless access network 100, as detailed in, e.g., 3GPP TS 32.420 V16.0.0.

According to some aspects, the method comprises executing S22 an automated neighbor relations (ANR) procedure to define the set of neighbor relation edges 420. The 3GPP ANR is specified in 3GPP TS 32.511 V16.0.0, and involves methods for establishing neighbor relations between cells in a wireless access network, such as the wireless access network 100 discussed above in connection to FIG. 1. The ANR procedures in 3GPP TS 32.511 V16.0.0 can be used with advantage to construct the initial set of neighbor relation edges 420 which connect at least some of the nodes 110, 130, 160, 410 of the wireless access network 100. However, since this initial relationship graph may contain a considerable number of edges, it is often advantageous to apply the herein proposed filtering techniques to reduce the number of edges that need to be considered by the machine learning structure.

The method optionally also comprises obtaining S23 one or more of the neighbor relation KPIs from an NWDAF 300 of the wireless access network 100, 400. An advantage of exploiting the NWDA for obtaining this type of information is that information from nodes more than one hop away from a given node can be obtained reliably and efficiently. In fact, the NWDA can be used to construct a global set of neighbor relation edges for an entire network, or at least a part of a network. The pruning can then be performed by the NWDAF, which may already be in possession of the relevant neighbor relation KPIs necessary to perform the filtering operation, in order to obtain the relational graph to use in distributed machine learning at each node in the wireless access network 100. Several examples of the tasks which can be performed by the NWDAF in this context will be discussed below in connection to FIG. 7.

An important property of the method is that a subset of the neighbor relation edges 420 is selected S3 for each node. The selected subset of neighbor relation edges 420 is associated with one or more neighbor relation KPI that meets a pre-determined acceptance criterion. Thus, the initial set of neighbor relation edges is pruned in order to remove some of the less relevant edges, given the application at hand. For example, in an RL application, the neighbors of a given agent can be filtered using, e.g., a mobility-related KPI such as HO success rate per cell relation. Generally, a neighbor relation KPI represents a metric which involves operations in at least two nodes in the plurality of nodes 110, 130, 160, 410. Many performance metrics can be determined on a cell basis. However, neighbor relation KPIs are different since neighbor relation KPIs involve at least two cell. In other words, while some KPIs take one cell identification as an argument, neighbor relation KPIs require two or more cells as argument.

After the filtering operation, the method forms S4 a relational graph for each node 110, 130, 160, 410 based on the respective selected subset of neighbor relation edges 420 for the node, and also performs S5 distributed machine learning over the nodes in the wireless access network 100, 400 based on the formed relational graph for each node. For the RL example, each agent then receives gradient update messages from its neighbors in the relational graph (the filtered initial set of neighbors). This can be done, e.g., using a new proprietary message from the neighbor cell on X2-C or indirectly via some form of data analytics function, such as the NWDAF 300 discussed above.

For many applications of network optimization, it has been discovered that mobility of users between cells, or between different network functions, is a good measure of similarity, which can be used with advantage to construct the relational graph. Thus, the method may comprise defining S21 the set of neighbor relation edges 420 as edges associated with a hand-over related KPI and/or a user mobility related KPI. An example of this type of KPI is the number of successful HO attempts performed which involve a pair of cells. Another example is a number which quantifies the number of users that are within range of both access points, i.e., which are located at the cell border in-between two access points. Geographical similarity may also be taken as an aspect of mobility since cells which are distant from each other rarely exhibit any mobility at all.

The filtering operation. i.e., the selection of a subset of neighbor relation edges to use in machine learning for each node, can be performed in a variety of ways. For instance, the method may comprise selecting S31 the subset of the neighbor relation edges 420 for each node as a number of neighbor relation edges 420 among the neighbor relation edges 420 associated with highest neighbor relation KPI, or as a pre-determined fraction of edges. Alternatively, the method may comprise selecting S32 the subset of the neighbor relation edges 420 for each node as the neighbor relation edges 420 having respective neighbor relation KPIs above a pre-determined acceptance threshold.

When selecting the subset of the neighbor relation edges, for each node, as a number of neighbor relation edges among the neighbor relation edges associated with highest neighbor relation KPI this may comprise, but is not limited to comprise, selecting the neighbor relation edges with the highest neighbor KPIs. According to embodiments, a number n neighbor relation edges are randomly selected from a number m of the neighbor relation edges with the highest neighbor KPIs, wherein n<m.

Alternatively, the subset of the neighbor relation edges 420 for each node can be selected S33 based on a feature selection method such as forward selection, backwards elimination, or recursive feature elimination (RFE). Such methods are generally known and will therefore not be discussed in more detail herein.

It is appreciated that the filtering can be a fixed filtering or an adaptive filtering. For instance, the number of neighbor relation edges 420 or the fraction of edges to maintain in the selected subset can be pre-determined, or it can be adapted. To adapt this subset selection parameter, the overall computational load of the machine learning process can be monitored, and the number of edges can be increased and decreased to maintain an acceptable computational load during training. The number of edges to retain, or the fraction of edges to retain can also be adjusted in dependence of some inference performance criterion. Thus, the number of edges to use in machine learning can be varied and the performance of the resulting inference can be monitored. By adjusting the number of edges to use in the machine learning process, the performance can often be improved. Thus, it is appreciated that the size of the relational graph, i.e., the number of edges in the initial set of neighbor relation edges to retain as the selected subset can be seen as a tuning parameter of the machine learning process.

According to other aspects, the method comprises performing S51 the distributed machine learning in the wireless access network 100, 400 as an RL procedure involving a plurality of RL agents, such as a multi-agent RL procedure. MARL. Some examples of RL-based machine learning processes will be discussed below. In case of a MARL implementation, the method preferably comprises initializing S1 a plurality of RL agents, where each RL agent is associated with a node 110, 130, 160, 410 in the wireless access network 100, 400 and also with a respective RL agent policy, where the method further comprises updating S511 the RL policy of an RL agent associated with a node 110, 130, 160, 410 based on one or more gradient updates received from other RL agents in the relational graph for the node. The method advantageously also comprises registering each RL agent by an NRF of the wireless access network 100. The NRF is part of the SBA shown in FIG. 2. This way, different entities in the network 100 can obtain information about which agents that are initialized in the network 100.

Of course, the relational graph which results from the techniques disclosed herein can also be used in, e.g., performing S52 the distributed machine learning in the wireless access network 100, 400 as a federated learning (FL) procedure.

Generally, the methods disclosed herein may comprise performing S53 an optimization of a network parameter associated with the wireless access network 100, 400 as a distributed machine learning procedure based on the formed relational graphs, such as optimization of an antenna tilt parameter S531. However, the methods may also be used for other applications. For instance, the methods have shown satisfactory performance when applied to perform S54 secondary carrier prediction in the wireless access network 100, 400 as a distributed machine learning procedure based on the formed relational graphs.

FIG. 6B illustrates another method which can be seen as an example realization of the above-discussed more general methods. The method is a computer-implemented method for distributed machine learning, performed in a wireless access network 100, 400 comprising a plurality of nodes 110, 130, 160, 410. The method comprises initializing Sb1 an RL agent for each node in the plurality of nodes 110, 130, 160, 410,
constructing Sb2 a network graph for the wireless access network comprising the nodes 110, 130, 160, 410 at least partially interconnected by pair-wise neighbor relation edges 420,
assigning Sb3 a graph edge weight to each neighbor relation edge 420 in the network graph, based on an associated neighbor relation KPI.
filtering Sb4 the neighbor relation edges 420 based on the neighbor relation KPIs and on a pre-determined acceptance criterion, and for each RL agent,
obtaining Sb5 the graph edge weights of the filtered neighbor relation edges 420 associated with the RL agent.
receiving Sb6 a policy update from each of the RL agents associated with the filtered neighbor relation edges 420, and
updating Sb7 the policy of the RL agent based on the policy updates received by the RL agent.

Consider the flow chart 700 in FIG. 7, where agents of the machine learning structure are first initialized 710. Depending on the use case, we deploy an agent per cell, per node, per NF etc. An agent constitutes a vertex in the network graph. FIG. 5 shows an example 500 of agents 510 which have been associated to each other in a relational graph, with edges 520 that have associated weights 530. For the example of optimizing antenna tilt the agents have a one-to-one mapping to cells, but this is not always the case. Cells in turn have a natural connection to other cells in the network—these connections arise due to users moving through the network performing handovers. This means that neighbor relation edges and neighbor relation KPIs are most likely relevant in forming the relational graph. However, the deployment and the use-case will determine what KPIs are relevant to consider when constructing the relational graph.

Each NF registers 720 its agent service in the NRF. This allows the NWDAF or other NFs in subsequent steps to discover the agent services in the network. Each agent also has an associated agent policy network model with associated model weights.

The NWDAF then constructs 730 a network graph of neighbor relation edges. For each registered agent service, the NWDAF collects PM data for each of the cell relations found, e.g., by ANR. The function then calculates edge weights 530 for the neighbor relation edges 520 based on PM data. Each cell relation is an edge in the network graph with an associated edge weight, as illustrated in FIG. 5. For example, the number of attempted handovers and the number of successful handovers are important metrics to consider since we want to minimize the number of failed handovers.

Cell performance metrics and key performance metrics are also important—it is preferred to reduce the drop rate and increase the cell throughput. However, individual NFs do not know the KPIs of neighbor NFs and NFs might not store historical performance metric data for the duration needed. The NWDAF therefore use the NWDA and data collection framework to collect 740 these performance metrics from OAM (or directly from NFs) and calculates edge weights for the entire network. Optionally, an individual NF can use NWDA to request data from neighbors. An edge weight can simply be the handover success ratio, or a formula made up of any available performance metrics. An important embodiment is calculating a similarity score between two cells, for example Euclidean distance or cosine similarity. A high similarity implies that two cells are similar and therefore can make better use of each other's gradients.

The edge weights can be the same in both the incoming and outgoing direction, or different. This corresponds to a directed or an undirected network graph. In the case of handover success rate, the outgoing and incoming success rates can be different and would require a directed network graph. The network graph is encoded as an adjacency matrix.

Note that in the case that the edge weights are calculated by performance metrics already available locally in the NFs, each NF can perform the calculations based on its own local information without involving the NWDAF. In this case, the NF itself can calculate the weights and distribute them to its neighbors. It should be noted that the direction of the edge in the network graph is important here, for example if we consider an undirected graph the two neighbors will have to agree on the edge weight.

At the third step, the neighbor relation edges are filtered 750. i.e., a subset of the neighbor relation edges are selected for each node. This is done by using for example mobility KPIs such as handover success rate per cell relation. Cell relations are ranked by their handover success rate, the number of handovers etc. The selection mechanism may comprise retaining a pre-determined number of edges, or a fraction of edges, or some other selection mechanism where the selected subset of neighbor relation edges is associated with one or more neighbor relation KPI that meets a pre-determined acceptance criterion. This effectively prunes the adjacency matrix (the relational graph) for use in the distributed machine learning process.

The edge weights are then distributed 760 to the different agents. For each agent, in this example, the NWDAF sends the filtered edge weights in the relational graph to each corresponding agent. The incoming and outgoing edges correspond to neighbors which the agents want to collaborate and coordinate with.

The agents receive gradient updates 770 of the local policy from its neighbors in the relational graph. The gradient updates are weighted according to the received edge weights. This can be done using a new proprietary or standardized message from the neighbor cell on X2-C or indirectly via NWDAF.

The machine learning model update is then performed using local data 780. The result is a gradient update from the original model. Finally, the machine learning structure can be used for inference 790. For instance, the updated policy/model can be used to set antenna tilt or predict coverage on another frequency.

It is noted that the network graph edge weights can either be calculated locally by each agent, hereinafter referred to as local case, or by a central entity, hereinafter referred to as central case, such as an NWDAF. In the local case, each agent will have knowledge about a subset of the complete network graph.

Neighbor relation KPIs used to calculate network weights can be fetched using NWDA. The sub-task 760 in FIG. 7 does not apply for the local case. This is advantageous from a privacy and security point of view and reduces communication between agents and the central entity since the network graph does not have to be transmitted. However, if neighbor KPIs are used to calculate the network graph edge weight, this adds to the communication volume.

In the central case, the NWDAF will have the complete network graph and communicate a subset of the graph to each agent. This is advantageous for analysis and troubleshooting. However, this also increases communication since a subset of the network graph needs to be transmitted to each client, although it is noted that network KPIs do not have to be transmitted to the clients since they are only used for calculating the network graph edge weights. The size of each of the contributions to the communication volume is determined by which KPIs are needed for a particular use-case, and the network graph topology. As stated earlier, depending on the use case, one agent is deployed per cell, per node, per NF etc. This affects the shape, size, degree and topology of the network graph.

In the case an agent is deployed per cell for a given machine learning application, the neighboring cells can be deployed on the same node, or another node. The KPIs for the intra-node neighbor cells are known and can be used to calculate the edge weights (sub-task 730 in FIG. 7). Inter-node neighbor cell KPIs have to be fetched via NWDAF/OAM and the NWDA-framework, as discussed above in connection to FIG. 2.

In the case one agent is deployed per node, the neighbor KPIs are not known. Furthermore, since KPIs such as handover success rate are calculated on a cell relation level, the weights have to be computed using all cell relations where the target cell belong to the neighbor node. This calculation can be an average, a maximum or minimum, or any suitable user-defined function. There may exist a use-case where agents are deployed on different types of entities. For simplicity it is assumed that all agents are deployed on the same kind of entity, for example cells.

Antenna tilt optimization aims at tuning the vertical tilt angle of Base Stations (BSs) antennas distributed in the network to optimize performance indicators representing the coverage, quality, and capacity in each cell of the network. Other examples of KPIs to optimize using the machine learning techniques discussed herein, i.e., based on the relational graphs discussed above, are:
a value of a network congestion parameter,
a value of a network quality parameter
a current network resource allocation,
a current network resource configuration,
a current network usage parameter,
a current network parameter of a neighbor communication network cell,
a value of a network signal interference parameter,
a value of a Reference Signal Received Power (RSRP) parameter,
a value of a Reference Signal Received Quality (RSRQ) parameter,
a value of a network signal to interference plus noise ratio (SINR) parameter,
a value of a network power parameter,
a current network frequency band,
a current network antenna down-tilt angle,
a current network antenna vertical beamwidth,
a current network antenna horizontal beamwidth,
a current network antenna height,
a current network geolocation, and
a current network inter-site distance,

We now consider an example of the above-discussed general methods applied in a multi-cell antenna tilt optimization scenario. The environment comprises a set [symbol] of UEs, indexed by i=1, . . . , | [symbol] |, where |⋅| denotes set cardinality. The environment further comprises a set [symbol] of cells, indexed by c=1, . . . , | [symbol] |. The antenna tilt θ_{t,c}, defined at time index t≥1 and for cell c=1, . . . , | [symbol] |, is the control variable. A set of KPIs, containing information about coverage and capacity in the cell are measured at time t for each cell c∈ [symbol] .

Let [symbol] (c) denote the set of filtered cell neighbors for a cell c (including the cell c). We now frame the problem of antenna tilt optimization in the RL setting. The constituent elements of the problem are:
State: s_{t,c}=[ [symbol] , [symbol] ] contains the downtilt for all the cells contained in the neighbors and a set of network performance indicators at time t and for cell c.
Action: a_{t,c}∈{˜ϵ, 0, ϵ}, a decision on whether to increase, decrease the downtilt of a discrete amount of magnitude ϵ or keep the same tilt.
Reward: r_{t,c}=f(KPl_{t+1,c}−KPl_{t,c}), measures the variation of the state KPIs from time t to time t+1 when executing action a_{t,c} in state s_{t,c}.

In the following we particularize the parts of a method according to the present disclosure for the antenna tilt optimization use-case.

We consider a policy π_{w}, parametrized by a weight vector w∈R^{d}. The policy acts on each cell c=1, . . . , | [symbol] |. The policy can be learned using different methods that are not the main scope of this disclosure. For example, in some embodiments, A DQN method may be used. In such case, the state-action value function Q_{w}(s, a), parametrized by the same parameter vector w∈R^{d} as before, are learned using the DQN algorithm which is previously known in the art. After the state-action value function is learnt, an optimal policy is derived as

πw(s_{t,c})∈arg [symbol] Q_{w}(s_{t,c},a).

To find connections between cells, we look at PM indicators reflecting user mobility within neighboring cells. Particularly, for all cells c=1, . . . , | [symbol] |, the graph edge weights, in this example denoted as Pc, are computed using for example the number of handover attempts, handover success ratio or a similarity score between the neighboring cells. The top n relations, out of the | [symbol] (c)|, based on the graph edge weights, are kept. Then, for each agent, the NWDAF sends the filtered edge weights in the relational graph to each corresponding agent. From each neighbor in the relational graph, an agent then receives gradient updates to its the policy model. The policy parameter update step is executed at time t as and at each cell as:

$${{w}_{t + 1} = {w}_{t} - {α}_{t} \frac{1}{n} {\sum }_{c = 1}^{n} {ρ}_{c} \cdot {∇}_{w} [ ( {Q}_{w} ( {s}_{t , c} , {a}_{t , c} ) - {y}_{t , c} ) )}^{2} ] ,$$

where wₜ∈R^{d} is the parameter vector at time t. ∇_{w}(⋅) represents the gradient operator, in which the i-th entry represents the partial derivative of ⋅ with respect to the i-th component of w, and ρ_{c} are the edge weights. Here, y_{t,c} represents the target of the update at time t for cell c, and can be written as r_{t,c}+γ maxₐQ_{w}(s′_{t,c}, a). The inference for each cell is simply executed as

π_{w}(s_{t,c})∈arg [symbol] Q_{w}(s_{t,c},a).

According to another example, the above-discussed general methods are used for secondary carrier prediction. Secondary carrier prediction aims to predict if a UE has coverage on a secondary frequency without measuring on the secondary frequency. Secondary carrier prediction is another example network operation where the herein disclosed methods can be applied with advantage. Using secondary carrier prediction, the UE does not need to perform inter-frequency measurements, leading to energy savings at the UE. However, frequent signaling of source carrier information that enables prediction of the secondary frequency can lead to an additional overhead and should thus be minimized. The risk of not performing frequent periodic signaling is missing an opportunity of doing an inter-frequency handover to a less-loaded cell on another carrier. The input features are RSRP values from neighboring cells on the source frequency, as well as cell specific features. Output classes are cells on the target frequency. In one embodiment, this invention is used in the source cell to filter output classes. These output classes have a one-to-one mapping to a target cell, or a target frequency. In another embodiment, this invention is used to filter neighbors from which we receive gradients, i.e. in decentralized learning.

For example, a target cell to which we had a historical high number of handover attempts (as determined by PM-counters), is a viable candidate for future handovers, i.e. it should have a higher edge weight. A target cell with high number of handovers, but a low handover success rate is a target cell for which we potentially need to sample more from in order to increase the accuracy of our machine learning model, and therefore it will have a higher edge weight. A target cell with a high similarity score, (for example a high cosine-similarity or any other similarity measurement), is also a cell that can have a high edge weight in the network graph.

In a first implementation example, a decentralized use-case is considered with no communication between models. The herein proposed techniques are used to create a manageable (easily learned) but local machine learning problem that can be trained using only local data by filtering target classes. Note that the method sub-tasks of Initialize agents. Construct network graph. Filter network graph edges. Distribute edge weights, and Use filtered input features. Are repeated in each of the below discussed example implementations. The sub-tasks are indicated as tasks A-E in FIG. 7, where the part E “Use filtered input features” may comprise one or more sub-tasks.

The first implementation example method comprises:
A—Initialize agents. We initialize one model per cell, (or optionally per node). Each of these agents will act independently of each other.
B—Construct network graph. To find connections and similarities between cells we look at PM indicators reflecting user mobility within neighboring cells. Particularly, all the graph edge weights are computed using for example the number of handover attempts, handover success ratio or a similarity score between the neighboring cells. This can be performed locally in the cell by the agent, or optionally by the NWDAF.
C—Filter network graph edges. The top n relations, based on the graph edge weights, are kept. This can be performed locally in the cell by the agent, or optionally by the NWDAF.
D—Distribute edge weights. For each agent, the NWDAF sends the filtered edge weights in the adjacency matrix to each corresponding agent.
E—Use filtered input features. Each of filtered set of neighbors on the target frequency are used as output classes.

(Optionally) Repeat the above steps for input features. Input features are for example RSRP measurements from neighboring cells on the source frequency. Here we would like to keep the most important ones. An alternative is to use the most frequent cells as seen in measurement reports.

In a second implementation example, we consider the second carrier prediction use-case. This is a decentralized use-case with inter-agent communication. This example method comprises:
A—Initialize agents. We initialize one model per cell, or per node.
B—Construct network graph. To find connections between cells, we look at PM indicators reflecting user mobility within neighboring cells. Particularly, for all cells the graph edge weights are computed using for example the number of handover attempts, handover success ratio or a similarity score between the neighboring cells.
C—Filter network graph edges. The top n relations, based on the graph edge weights, are kept.
D—Distribute edge weights. For each agent, the NWDAF sends the filtered edge weights in the adjacency matrix to each corresponding agent.
E—Use filtered input features. Each of filtered set of neighbors on the target frequency are used as output classes.

Repeat the above steps for input features. Input features are for example RSRP measurements from neighboring cells on the source frequency. Here we would like to keep the most important ones. An alternative is to use the most frequent cells as seen in measurement reports.

Importantly, two nodes can only share gradients if the model architectures are compatible. For instance, this means that the input and outputs should be the same.

Train machine learning model using Federated Learning. Optionally use the per agent weight as weight in the weighted average of gradients that are received from each agent.

In a third example, the secondary carrier prediction problem is revisited, where the training is done using federated learning—i.e. the communication is made up by local model updates (gradients) sent to a central server. This third example method comprises:
A—Initialize agents. We initialize one global model and one model (copy of the global model) per cell, or per node.
B—Construct network graph. To find connections between cells, we look at PM indicators reflecting user mobility within neighboring cells. Particularly, for all cells c=1, . . . , | [symbol] |, the graph edge weights, denoted as are computed using for example the number of handover attempts, handover success ratio or a similarity score between the neighboring cells.
C—Filter network graph edges. The top n relations, out of the |N(c)|, based on the graph edge weights, are kept. Optionally, a weight can be added to each agent that is used as a weight to weight gradient updates. This weight is an attribute of the agent itself, and is different from the weight per edge previously discussed.
D—Distribute edge weights. For each agent, the NWDAF sends the filtered edge weights in the adjacency matrix to each corresponding agent.
E—Use filtered input features. From each of filtered set of neighbors on the target frequency, use these as output classes.

Repeat the above for other input features. Input features are for example RSRP measurements from neighboring cells on the source frequency. Here we would like to keep the most important ones. An alternative is to use the most frequent cells as seen in measurement reports.

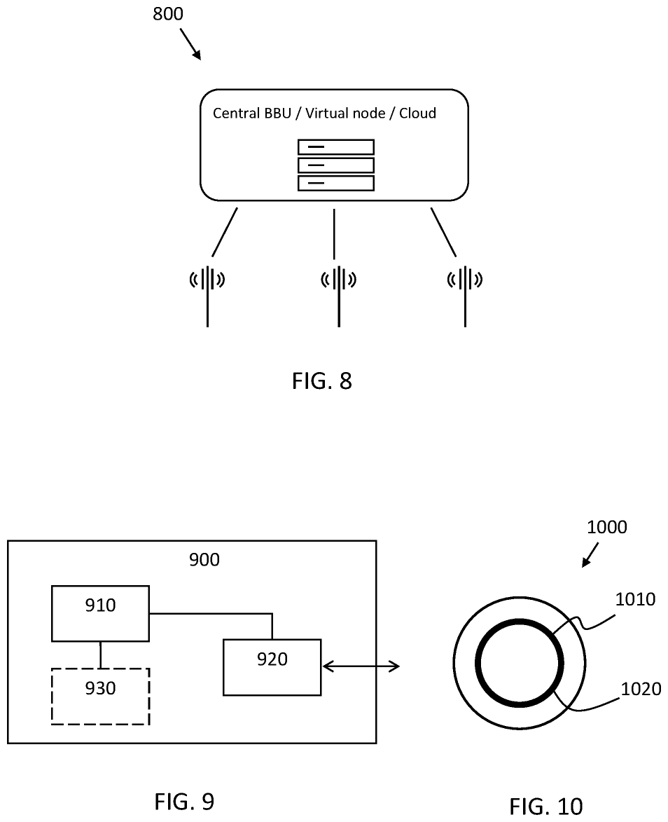

FIG. 8 illustrates various realizations 800 of the methods discussed above. The methods and receivers discussed above may be implemented in a 5GC node which could be deployed in a centralized manner or in a virtual node in the communications network 100. The split between the physical node and the centralized node can be on different levels. Parts of the proposed methods may of course also be implemented on a remote server comprised in a cloud-based computing platform.

FIG. 9 schematically illustrates, in terms of a number of functional units, the general components of a network node 900 according to embodiments of the discussions herein. Processing circuitry 910 is provided using any combination of one or more of a suitable central processing unit CPU, multiprocessor, microcontroller, digital signal processor DSP, etc., capable of executing software instructions stored in a computer program product, e.g., the form of a storage medium 930. The processing circuitry 910 may further be provided as at least one application specific integrated circuit ASIC, or field programmable gate array FPGA.

Particularly, the processing circuitry 910 is configured to cause the device 900 to perform a set of operations, or steps, such as the methods discussed in connection to FIGS. 6A and 6B and the discussions above. For example, the storage medium 930 may store the set of operations, and the processing circuitry 910 may be configured to retrieve the set of operations from the storage medium 930 to cause the device to perform the set of operations. The set of operations may be provided as a set of executable instructions. Thus, the processing circuitry 910 is thereby arranged to execute methods as herein disclosed. In other words, there is shown a network node 1900, comprising processing circuitry 910, a network interface 920 coupled to the processing circuitry 910 and a memory 930 coupled to the processing circuitry 910, wherein the memory comprises machine readable computer program instructions that, when executed by the processing circuitry, causes the network node to execute one or more of the operations, functions and methods discussed herein.

The storage medium 930 may also comprise persistent storage, which, for example, can be any single one or combination of magnetic memory, optical memory, solid state memory or even remotely mounted memory.

The device 900 may further comprise an interface 920 for communications with at least one external device. As such the interface 920 may comprise one or more transmitters and receivers, comprising analogue and digital components and a suitable number of ports for wireline or wireless communication.

The processing circuitry 910 controls the general operation of the device 900, e.g., by sending data and control signals to the interface 920 and the storage medium 930, by receiving data and reports from the interface 920, and by retrieving data and instructions from the storage medium 930. Other components, as well as the related functionality, of the control node are omitted in order not to obscure the concepts presented herein.

FIGS. 8 and 9 illustrate example network nodes 800, 900 for implementing a distributed machine learning method performed in a wireless access network 100, 400 comprising a plurality of nodes 110, 130, 160, 410. The network nodes comprise:
processing circuitry 910;
a network interface 920 coupled to the processing circuitry 910; and a memory 930 coupled to the processing circuitry 910, wherein the memory comprises machine readable computer program instructions that, when executed by the processing circuitry, causes the network node to:
define a set of neighbor relation edges 420 which connect at least some of the nodes 110, 130, 160, 410 of the wireless access network, where each neighbor relation edge 420 is associated with at least one neighbor relation KPI,
select a subset of the neighbor relation edges 420 for each node, wherein the selected subset of neighbor relation edges 420 is associated with one or more neighbor relation KPI that meets a pre-determined acceptance criterion,
form a relational graph for each node 110, 130, 160, 410 based on the respective selected subset of neighbor relation edges 420 for the node, and perform distributed machine learning over the nodes in the wireless access network 100, 400 based on the formed relational graph for each node.

FIGS. 8 and 9 also illustrate example network nodes 800, 900 for implementing a distributed machine learning method performed in a wireless access network 100, 400 comprising a plurality of nodes 110, 130, 160, 410. The network nodes comprise:
processing circuitry 910;
a network interface 920 coupled to the processing circuitry 910; and
a memory 930 coupled to the processing circuitry 910, wherein the memory comprises machine readable computer program instructions that, when executed by the processing circuitry, causes the network node to:
initialize a RL agent for each node in the plurality of nodes 110, 130, 160, 410,
construct a network graph for the wireless access network comprising the nodes 110, 130, 160, 410 at least partially interconnected by pair-wise neighbor relation edges 420,
assign a graph edge weight to each neighbor relation edge 420 in the network graph, based on an associated neighbor relation KPI,
filter the neighbor relation edges 420 based on the neighbor relation KPIs and on a pre-determined acceptance criterion, and
for each RL agent,
obtain the graph edge weights of the filtered neighbor relation edges 420 associated with the RL agent,
receive a policy update from each of the RL agents associated with the filtered neighbor relation edges 420, and
update the policy of the RL agent based on the policy updates received by the RL agent.

FIG. 10 illustrates a computer readable medium 1010 carrying a computer program comprising program code means 1020 for performing the methods illustrated in, e.g., FIG. 6A and FIG. 6B, when said program product is run on a computer. The computer readable medium and the code means may together form a computer program product 1000.

1. A computer-implemented method for distributed machine learning, performed in a wireless access network comprising a plurality of nodes,
the method comprising,
defining an initial set of neighbor relation edges which connect at least some of the nodes of the wireless access network, where each neighbor relation edge is associated with at least one neighbor relation key performance indicator, KPI, selecting a subset of the neighbor relation edges for each node, wherein the selected subset of neighbor relation edges is associated with one or more neighbor relation KPI that meets a pre-determined acceptance criterion,
forming a relational graph for each node based on the respective selected subset of neighbor relation edges for the node, and
performing distributed machine learning over the nodes in the wireless access network based on the formed relational graph for each node.

2. The method according to claim 1, comprising defining the set of neighbor relation edges as edges associated with a hand-over related KPI and/or a user mobility related KPI.

3. The method according to claim 1, where each neighbor relation edge is associated with a third generation partnership program, 3GPP, X2 connection between two nodes in the wireless access network.

4. The method according to claim 1, where a neighbor relation KPI represents a metric which involves operations in at least two nodes in the plurality of nodes.

5. The method according to claim 1, comprising executing an automated neighbor relations, ANR, procedure to define the set of neighbor relation edges.

6. The method according to claim 1, comprising obtaining one or more of the neighbor relation KPIs from a network data analytics function, NWDAF, of the wireless access network.

7. The method according to claim 1, comprising selecting the subset of the neighbor relation edges for each node as a number of neighbor relation edges among the neighbor relation edges associated with highest neighbor relation KPI or as a fraction of neighbor relation edges among the neighbor relation edges associated with highest neighbor relation KPI.

8. The method according to claim 1, comprising selecting the subset of the neighbor relation edges for each node as the neighbor relation edges having respective neighbor relation KPIs above a pre-determined acceptance threshold.

9. The method according to claim 1, comprising selecting the subset of the neighbor relation edges for each node based on a feature selection method such as forward selection, backwards elimination, or recursive feature elimination.

10. The method according to claim 1, comprising performing the distributed machine learning in the wireless access network as a reinforcement learning, RL, procedure involving a plurality of RL agents, such as a multi-agent RL procedure, MARL.

11. The method according to claim 10, comprising initializing a plurality of RL agents, where each RL agent is associated with a node in the wireless access network and also with a respective RL agent policy, where the method further comprises updating the RL policy of an RL agent associated with a node based on one or more gradient updates received from other RL agents in the relational graph for the node.

12. The method according to claim 10, comprising registering each RL agent by a network repository function, NRF, of the wireless access network.

13. The method according to claim 1, comprising performing the distributed machine learning in the wireless access network as a federated learning, FL, procedure and/or as a Deep Q Learning, DQN, method.

14. The method according to claim 1, comprising performing an optimization of a network parameter associated with the wireless access network as a distributed machine learning procedure based on the formed relational graphs.

15. The method according to claim 14, where the network parameter comprises an antenna tilt parameter.

16. The method according to claim 1, comprising performing secondary carrier prediction in the wireless access network as a distributed machine learning procedure based on the formed relational graphs.

17. (canceled)

18. (canceled)

19. A network node for implementing a distributed machine learning method performed in a wireless access network comprising a plurality of nodes,
the network node comprising:
processing circuitry;
a network interface coupled to the processing circuitry; and
a memory coupled to the processing circuitry, wherein the memory comprises machine readable computer program instructions that, when executed by the processing circuitry, causes the network node to:
define a set of neighbor relation edges which connect at least some of the nodes of the wireless access network, where each neighbor relation edge is associated with at least one neighbor relation key performance indicator, KPI,
select a subset of the neighbor relation edges for each node, wherein the selected subset of neighbor relation edges is associated with one or more neighbor relation KPI that meets a pre-determined acceptance criterion,
form a relational graph for each node based on the respective selected subset of neighbor relation edges for the node, and
perform distributed machine learning over the nodes in the wireless access network based on the formed relational graph for each node.

20. A computer-implemented method for distributed machine learning, performed in a wireless access network comprising a plurality of nodes, the method comprising
initializing a reinforcement learning, RL, agent for each node in the plurality of nodes,
constructing a network graph for the wireless access network comprising the nodes at least partially interconnected by pair-wise neighbor relation edges,
assigning a graph edge weight to each neighbor relation edge in the network graph, based on an associated neighbor relation key performance indicator, KPI,
filtering the neighbor relation edges based on the neighbor relation KPIs and on a pre-determined acceptance criterion, and
for each RL agent,
obtaining the graph edge weights of the filtered neighbor relation edges associated with the RL agent,
receiving a policy update from each of the RL agents associated with the filtered neighbor relation edges, and
updating the policy of the RL agent based on the policy updates received by the RL agent.

21. A network node for implementing a distributed machine learning method performed in a wireless access network comprising a plurality of nodes,
the network node comprising:
processing circuitry;
a network interface coupled to the processing circuitry; and
a memory coupled to the processing circuitry, wherein the memory comprises machine readable computer program instructions that, when executed by the processing circuitry, causes the network node to:
initialize a reinforcement learning, RL, agent for each node in the plurality of nodes,
construct a network graph for the wireless access network comprising the nodes at least partially interconnected by pair-wise neighbor relation edges,
assign a graph edge weight to each neighbor relation edge in the network graph, based on an associated neighbor relation key performance indicator, KPI,
filter the neighbor relation edges based on the neighbor relation KPIs and on a pre-determined acceptance criterion, and
for each RL agent,
obtain the graph edge weights of the filtered neighbor relation edges associated with the RL agent,
receive a policy update from each of the RL agents associated with the filtered neighbor relation edges, and
update the policy of the RL agent based on the policy updates received by the RL agent.
